(19) United States
(12) Patent Application Publication
(10) Pub. No.: US 2005/0167044 A1
(43) Pub. Date: Aug. 4, 2005

(54) Labels and method of manufacture thereof

(75) Inventors: Malcolm Keith Exeter, Buckinghamshire (GB); Paul Geoffrey Atkins, Buckinghamshire (GB); Ian Thompson, Buckinghamshire (GB)

Correspondence Address: MCCORMICK, PAULDING & HUBER LLP, CITY PLACE II, 185 ASYLUM STREET, HARTFORD, CT, 06103, US

(73) Assignee: Field Group PLC

(21) Appl. No.: 10/513,487

(22) PCT Filed: Apr. 16, 2004
(86) PCT No.: PCT/GB04/01661

(30) Foreign Application Priority Data
Apr. 17, 2003 (GB) 0308934.9

(51) Int. Cl. B32B 31/00

(52) U.S. Cl. 156/302

(57) ABSTRACT

A method of producing self-adhesive labels carried on a release backing material is described. This method provides a plurality of self-adhesive carrier labels across the width of a web of carrier substrate with at least one discrete label components, such as a leaflets, booklets, holograms and security devices, being applied to each respective carrier label. The invention provides a plurality of separate label component applicators across the width of the web, one for each respective label component to be applied. There is also provided a registration means to ensure registration of each label component with its respective carrier label. In this way the method provides for the manufacture of multi-layered combinations of individual labels to a base carrier using separate and specific component applicators for each label across the width of the web.

### CROSS-REFERENCE TO RELATED APPLICATIONS

This application is entitled to the benefit of and incorporates by reference essential subject matter disclosed in International Patent Application No. PCT/GB2004/001661 filed on Apr. 16, 2004 and British Patent Application No. 0308934.9 filed on Apr. 17, 2003.

### FIELD OF THE INVENTION

The present invention relates to a label and a method of manufacturing labels. In particular, the invention relates to a method of manufacturing a multi-laminar label, comprising a self-adhesive base label which serves as a carrier for additional layers comprising, for example leaflets or booklets including information relevant to the product to which the label is to be applied.

### BACKGROUND OF THE INVENTION

In the current market conditions, there is a growing requirement to provide consumers with increased product information. This need can stem from legal requirements (for example for pharmaceutical products or agro-chemical products), and for exported goods, the requirement is to provide repeats of the same information in various languages.

The need for information has traditionally been addressed by providing “leaflet” labels, in which information provided on a self-adhesive product label is supplemented with a folded leaflet carried on the base label. The leaflet may be provided with a front cover flap which is releasably adhered, either to the carrier label, or to the product itself, to provide the user with repeated access to the information contained within the leaflet. In an alternative arrangement, a self-adhesive cover is provided over the leaflet to both protect the leaflet, and provide resealable access to the leaflet's contents.

These leaflet labels also compete for space on the product with other matter, such as security tags and pricing information. Where the size of the product is limited, such as on camera film containers, computer consumables etc, the “footprint” of the leaflet must be kept to a minimum, which can result in increased leaflet bulk. Bulky labels can be difficult to produce with conventional manufacturing methods, and difficult to apply to the products.

Recently, improvements in relation to manufacturing methods for such multi-laminar labels have concentrated on reducing the number of manufacturing steps to a minimum, and uniform handling of the web. Prior art methods describe building up a “composite” web in-line, the web comprising self-adhesive sheets of label stock, multiple leaflets across the width of the web and an over-laminate web of film, which are all brought together, and then die-cut in a single step through all the layers down to the release sheet to form rows of individual leaflet labels. All of the waste material is then stripped, also in a single step.

Whilst such methods have the advantage of producing high volumes of labels quickly and cost-effectively, the methods are unsuitable for less conventional label types.

It is an object of the present invention to provide a method of manufacture of labels which provides maximum flexibility as to the type of labels produced, whilst still being able to produce these cost effectively; and/or to provide improvements in relation to label manufacture generally.

### SUMMARY OF THE INVENTION

According to the present invention there is provided a method of producing self-adhesive labels carried on a release backing material, the method comprising the steps of:
providing a plurality of self-adhesive carrier labels across the width of a web of carrier substrate;
applying at least one discrete label component to each respective carrier label; characterised by
providing a plurality of separate label component applicators across the width of the web, one for each respective label component to be applied; and
providing registration means to ensure registration of each label component with its respective carrier label.

The invention therefore provides for the manufacture of multiple-layered combinations of individual labels, leaflets, booklets and films, (hereinafter referred to collectively as a “label components”), to the base carrier label, as produced by other conventional methods, but characterised by the use of a separate and specific component applicator for each label across the width of the carrier substrate web. If more than one label component is required in each end-label, then a further set of separate component applicators are provided downstream.

Therefore, the number of specific label component applicators across the width of the web is determined by the SUBSTITUTE number of streams of labels to be produced, and the number of component applicators along the length of the web is determined by the number of label components required for the final end-label.

By providing multiple and specific label component applicators across the width of the web, the method can provide, in a single operation, a composite “label” product comprising various combinations of leaflets, labels and films as produced by conventional methods. In an embodiment, the label component comprises a multi-layered leaflet or booklet. The leaflet or booklet may be applied either with the “Closed Folded Edge” trailing or leading in the direction of carrier web progression. Booklets and multi-layered leaflets in this case may refer to forms of bindery such as stitched, spine glued, glued-seam, extended flap, extended cover, or covered.

However, the method can also be used to produce final composite labels incorporating label components including decorated laminates, multi-leaflets, booklets, batteries and/or electronics in the form of circuit boards, micro-chips, smart cards, security information and tags (such as RFID), and other label components which cannot readily be incorporated into a composite label produced by existing label manufacturing products.

The label component applicator may comprise an over-labelling applicator, a web or sheet feed applicator and/or a hopper dispenser. It is envisaged that a single applicator apparatus may be arranged to provide multiple label component applicators (e.g. hopper apparatus with multiple dispensing hoppers). An advantage of the method of the present invention is that the component applicator can be specifically selected for the particular label component to be applied. For example, an over-label applicator is particularly preferred when the label component to be applied is a label of an over-laminate film.

The use of two or more over-laminating dispensers in a single stream enables two or more over-laminates to be affixed to one base carrier label product. This may further enhance the product, allowing security information, for example, to be covered or disguised, and/or allows different regions of the base carrier label to have different and/or multiple over-labels.

By providing a multi-layer label comprising a number of label components, it is possible to provide a composite label fulfilling a number of functions. For example, the resultant label may include both a product information leaflet and an overt or covert security device. In this way, the need to apply two separate items to the product is avoided, reducing handling costs and requiring less space on the product itself. This makes the security tagging of small but expensive products a much more realistic option, where previously, space restrictions prevented the use of such devices.

By providing a separate component applicator for each label component to be applied, variable end-label effects can be achieved in a single process run. By careful selection of the component applicators and label components, it is possible to apply a different label components to each stream across the width of the web, so that a variety of end-label types can be produced simultaneously. This allows, SUBSTITUTE for example, the geometric shape, image and/or information to be varied across the web.

The method also allows different combinations of different pre-shaped components, including an over-laminate label, to be placed on different shaped and pitched carrier labels simultaneously, but then for each stream to be individually slit from its neighbouring one for individual subsequent processing. This facilitates differing and varying marketing information and designs to be affixed to carrier labels in the same in-line production run, and even the supply of alternate leaflets to sequential carrier labels or double leaflets to a single carrier label.

In a similar way, the dispensing of the label components by use of two or more applicators may achieve additional variations of end product for each base carrier label stream sequence. Using this system, label components may be introduced “randomly”. This facility has benefits in market areas such as toys, security and special promotional work where “special” over-laminate labels can be applied to produce “winning numbers” or special security effects and codes within a sequence of products.

Alternatively, or additionally, by providing more than one component applicator type per stream, and by incorporating the appropriate control means, the characteristics of the label component may be varied over time to provide a variety of end-labels types within a particular stream.

The provision of a registration system between each label component applicator and its respective carrier label ensures that each label component is dispensed in a phased and controlled way. The adoption of a single continuous in line operation has the further advantage of significant production costs and register benefits, because of the ability to register all the base carrier labels and each label component far more accurately to each other than is possible if they are produced and applied in a non continuous in-line way.

High registration accuracies have been particularly difficult to achieve using known disjointed non-continuous batch production, and particularly when using web materials which have a tendency to deform and cause registration movement through geometric shrinkage changes by virtue of the nature of the processes (e.g. using UV inks and hot UV lamps to cure the inks), or through register loss through having to re-register each time the next stage of production takes place.

In an embodiment, the method includes the additional initial step of manufacturing the self-adhesive carrier labels from a web of label stock as part of the in-line process.

In an embodiment, where multiple label components are provided on the same carrier label, adhesive applications stages may be included to provide for permanent or releasable adherence of the label components to the base carrier label and/or other label components.

In an embodiment, it is also envisaged that the end-label product may comprise more than one base carrier label (having its own label component(s)) placed on top of another base carrier label, having its own combination of label components.

According to a further embodiment of the invention there is provided a method of producing self-adhesive labels carried on a release backing material, the method comprising the steps of:
providing a self-adhesive carrier labels on a web of carrier substrate; characterised by
applying a plurality of discrete label components across the width of the label;
providing a plurality of separate label component applicators across the width of the label, and
providing registration means to ensure registration of each label component with its respective carrier label.

In this way, the invention provides for the manufacture of a composite label having multiple label components, adjacent one another on the carrier label. Additional label components may be applied to one or more of the applied label components downstream. In a further embodiment, a separate label component applicator is provided for each respective label component to be applied.

In a further embodiment of the invention there is provided a method of producing self-adhesive labels carried on a release backing material, the method comprising the steps of:
providing a plurality of self-adhesive carrier labels across the width of a web of carrier substrate;
applying at least one label component to each respective carrier label; characterised by
providing a plurality of separate label component applicators across the width of the web, one for each respective label component to be applied; and
providing registration means to ensure registration of each label component with its respective carrier label.

In this embodiment, a label component may be applied across one or more of the carrier labels, for example, the label component may comprise a multiple leaflet, or an over-laminate film. It is envisaged that further processing, such as a die-cutting station may be required down stream, to separate the “multiple” label components to form individual final labels.

### BRIEF DESCRIPTION OF THE DRAWINGS

Embodiments of the invention will now be described, by way of example only, with reference to the following illustrative drawings in which:

FIG. 1 shows a base carrier label web required for the method of the present invention;

FIG. 2 shows the structure of the base carrier web used to produce the base carrier labels of FIG. 1;

FIGS. 3a and 3b show the process steps of two embodiments of the present invention;

FIGS. 4a to 4f show various label components which can be used in the method of the subject invention;

FIG. 5 shows the label component of FIG. 4f further provided with an over-laminate label; and

FIGS. 6a and 6b show a variation to the method shown in FIGS. 3a and 3b.

### DETAILED DESCRIPTION OF THE PREFERRED EMBODIMENTS

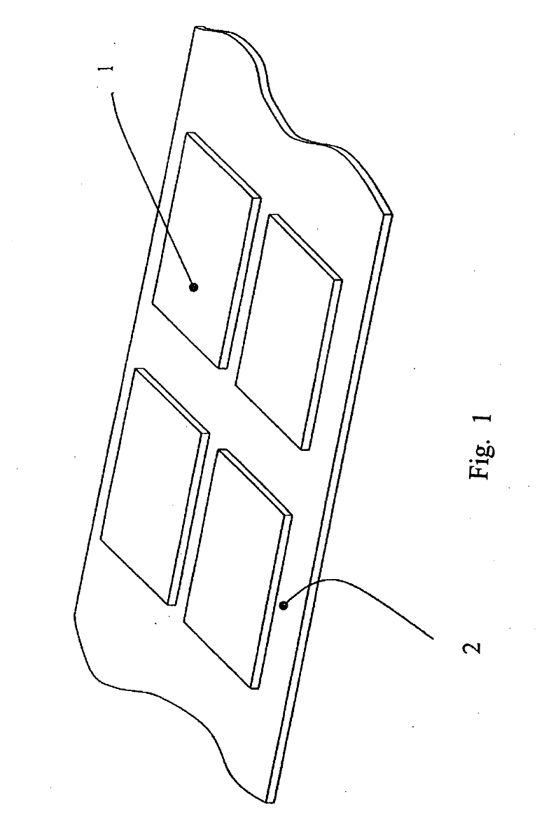

FIG. 1 shows a base carrier label, which has been formed on a continuous carrier substrate 2 and held in place using a suitable pressure sensitive adhesive. Multiple labels are provided across the width of the carrier substrate 2 (with two labels being illustrated in FIG. 1) with the configuration being repeated down the length of the carrier substrate 2. The top surface of the carrier substrate 2 may be coated, for example with a silicone material, to form a release sheet from which the carrier labels 1 can be easily removed.

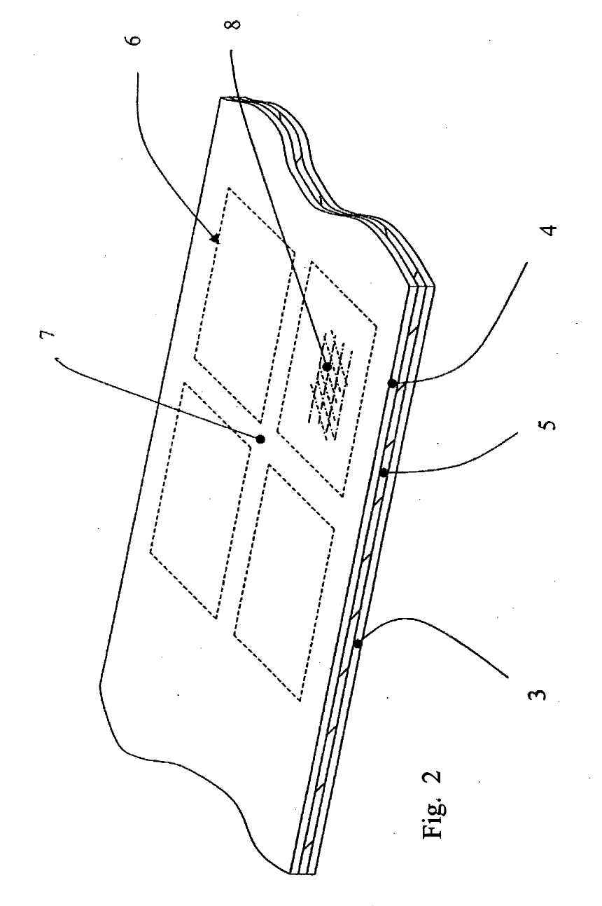

The carrier labels 1 may have previously been formed by cutting the shape of the labels from the upper layer of a typical multi-layer pressure sensitive label substrate stock such as shown in FIG. 2. The stock would normally comprise a paper carrier layer 3 with an appropriate silicone or wax release surface, a plastic (typically Polyethylene {PE}, Polypropylene {PP}, Polyester {PET}, Polyvinyl chloride {PVC}) or paper upper layer 4 and pressure sensitive glue layer 5.

Once the labels 1 have been cut to the required shape 6, the remaining waste material 7 from the upper layer 4 is removed. Printed, foiled and/or holographic images or information 8 may have been applied to the labels, either before the substrate stock is processed, or once the labels 1 have been cut to the required shape.

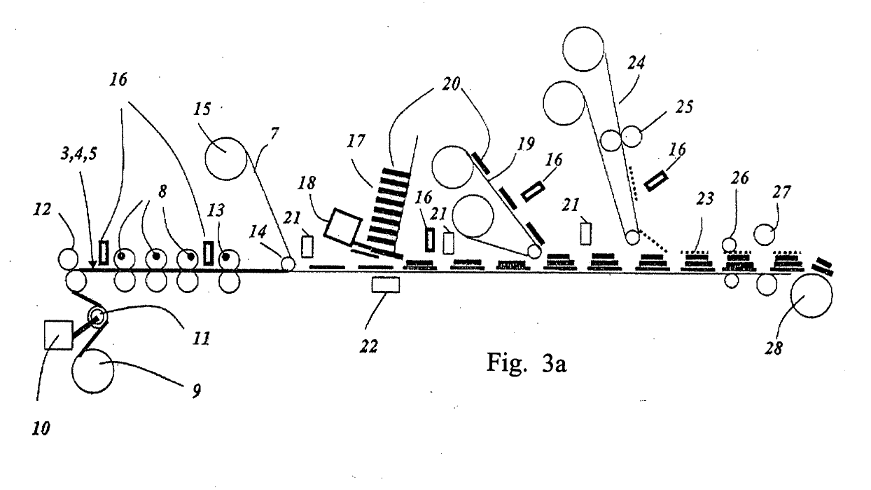

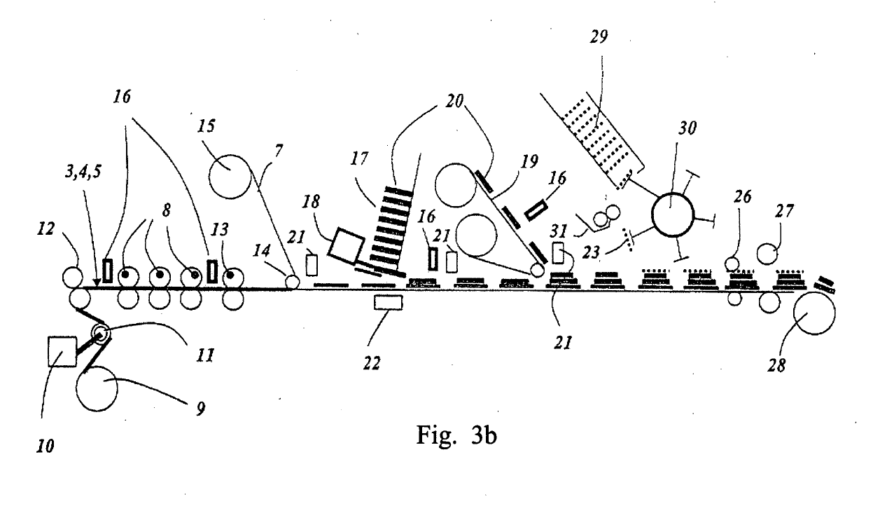

Within the scope of the present invention, it is envisaged that this process of forming the base carrier labels 1 to provide the base carrier web may be carried out as a separate process off-line, or it may be carried out in line, as an initial stage prior to the process of the subject invention. In FIGS. 3a and 3b, the formation of the base carrier web is included as part of a continuous in line process.

As can be seem in FIG. 3a, the label stock, typically comprising carrier layer 3, upper layer 4 and pressure sensitive glue layer 5, is unwound from a reel of such material 9 (which may have been be pre-imaged and pre-printed, as discussed above) through a web tension control and correction device 10 which is connected to a roller mechanism 11 for sensing the tension being created in the web material 9. The web tension device 10 controls the feed rate from the reel into the image forming units 8 by means of a speed controlled nip roller pairs 12.

The images formed at 8 are typically achieved by means of foil blocking, thermal transfer, printing of inks by such means as Flexographic, Lithographic, Screen, Gravure, Letter Press using direct, off-set or indirect means such as ink jet printing. The order, combination, colours, type and quality of ink, adhesive, number of foils or holograms may vary according to the application.

The cutting of the web to form the base carrier labels is achieved by means of cutting and finishing processes 13 which may include creasing and/or embossing and/or serrating by means of rotary and platen technologies.

The waste material area 7 is stripped from the carrier web 2 by means of a roller, bar or blade 14 and taken away to be chopped, compacted or wound on to a reel as in 15.

Sensor devices 16 placed at suitable positions along the process line detect register images on the web or base carrier label and control the positioning of subsequent imaging 8,13 etc through appropriate register control systems.

The dispensing and affixing of each label component (i.e. the label, leaflet, booklet, electrical component, battery etc) is applied to the carrier label 1 by means of a mechanical dispenser. The dispenser may use either a hopper-type single dispensation 17 with a placement gate mechanism 18, or from a web or sheet with the specific layer pre-formed and pre-applied (in the case of the web or sheet dispensation) for continuous dispensing 19 onto the base carrier label 1, and/or previously applied label component 20, or even in some cases, directly to the carrier web 2 of FIG. 1. In each case, a separate dispenser/applicator is provided for each stream of carrier labels 1 across the width of the web.

Registering devices 16 ensure that the each label components is dispensed in a phased and controlled way with its respective base carrier label 1.

Each label component is held in place by the use of adhesive pre-applied to specific areas on the base carrier label 1 through print, wheels or jets 21 on the base carrier label, the use of pressure sensitive adhesive already applied to the label component itself, or by such means as the use of static charge 22.

As can be seen, the method envisages that there may be one or more additional label components applied over the first label component to build up a composite label of multiple layers on each base carrier label 1, using the same application methods described above.

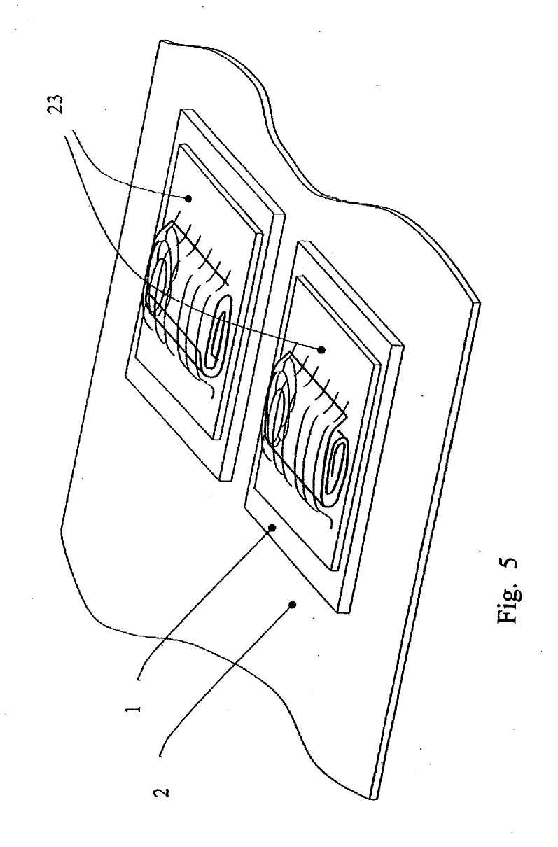

It is also envisaged that one of the label components to be applied may be a top cover, or over-laminate, to cover the multi-layered arrangement. The over-laminate may serve to protect the label components e.g. sealing the label component from dust, water or other contamination and ingress, and/or to provide a means of fixing them to the base carrier label 1. A thin over-laminate label layer 23 is applied to or over the label component(s) 20 (such as illustrated in FIG. 5) and/or base carrier label 1 and/or carrier substrate 2.

The over-laminate layer 23 in FIGS. 3a and 3b is typically formed from transparent or non-transparent material, which is of a plastic, and/or paper construction.

The layer 23 may be pre-cut, or cut 25 near the point of application. This over-laminate label is applied by means of a mechanical dispenser which uses, either a web or sheet supply 24 with the label pre-formed or pre-applied for continuous dispensing (see FIG. 3a) or a hopper type 29 single dispensation mechanism 30 (see FIG. 3b).

The hopper, web or sheet dispensing arrangement may be equipped with an adhesive application facility 21,31 to apply an adhesive region or regions to the over-laminate label, or alternatively (and more likely in the case of dispensing from a web feed mechanism), a pressure sensitive adhesive has been be pre-applied.

Where an over-laminate label is applied, the over-laminate label may be such as the shape of the base carrier label on all sides, or may be marrying with the edges of base carrier label on only one or more sides. In some instances the over-laminate label may not extend as far as the boundary of the base carrier label, or in some other circumstances may deliberately over-hang the base carrier label on some or all sides.

In one arrangement, the over-laminate label may only secure and hold the applied specific layer to the base carrier labels on as little as one side for configurations requiring a “hinge” type fixing, or more than one side in other cases.

Mechanisms such as nip rollers 26, or rollers or reciprocating platens with raised embossed stamping image arrangements may be used to help nip and bond the over-laminate label to the underlying layers, such as the base carrier label 1.

For end uses where repeated removal and re-fixing of the label components to the base carrier label 1 (or additional label components within a multi-layer composition), peelable adhesives may be used with associated applications of a silicon layers to enhance peelability.

At the end of the process, the carrier web 2 is re-wound by means of a tension-controlled re-winder 28.

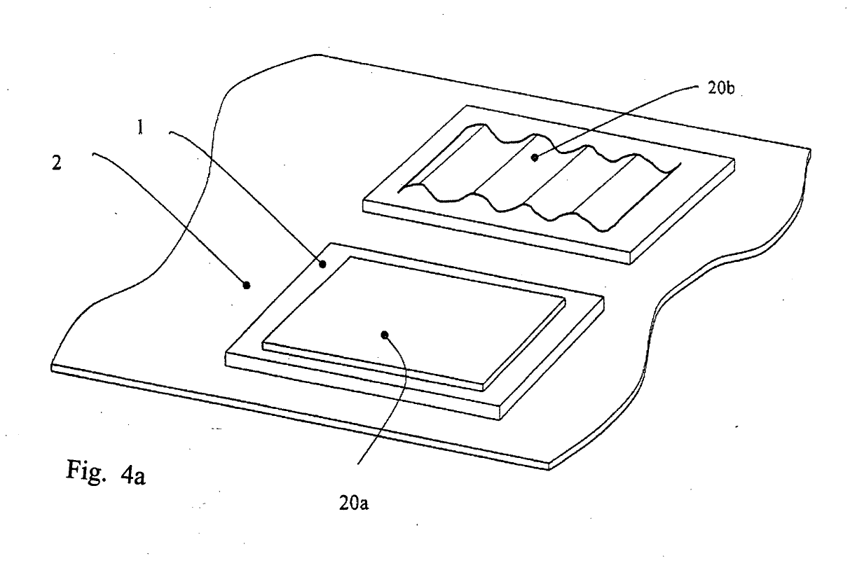

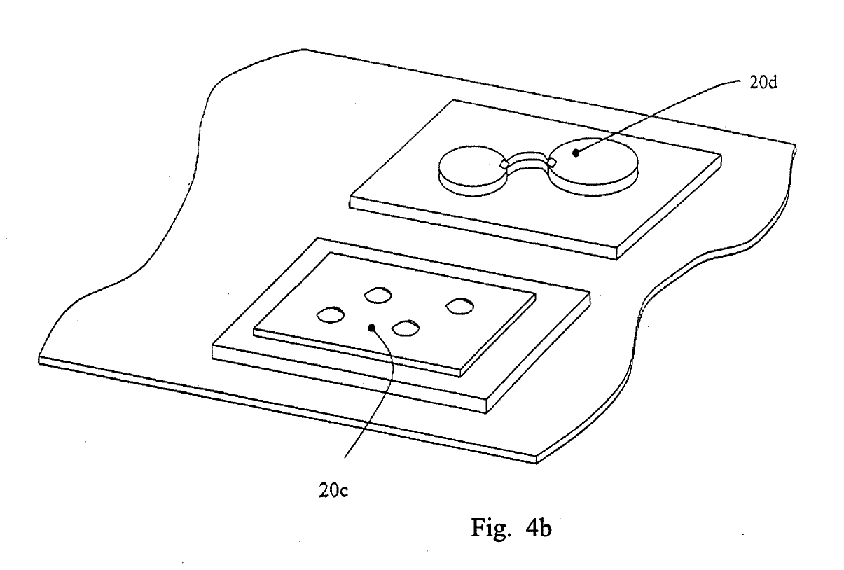

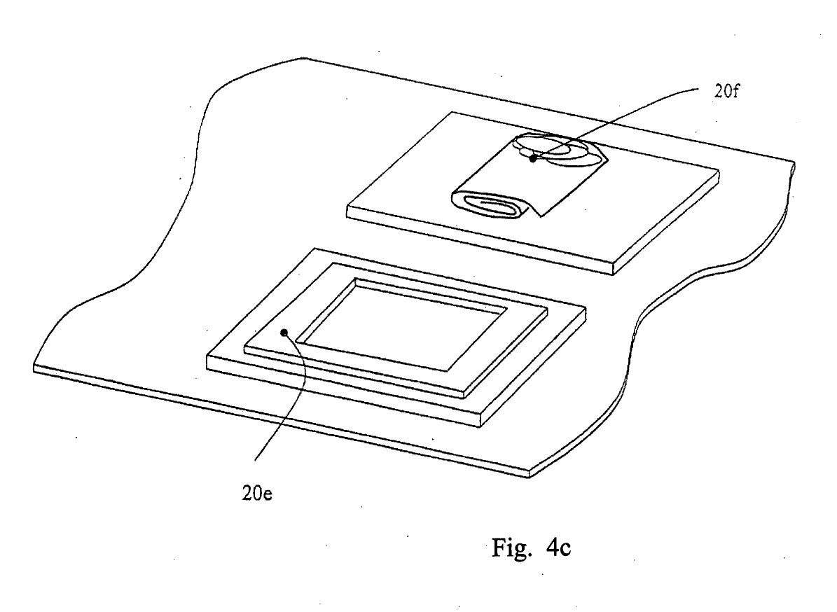

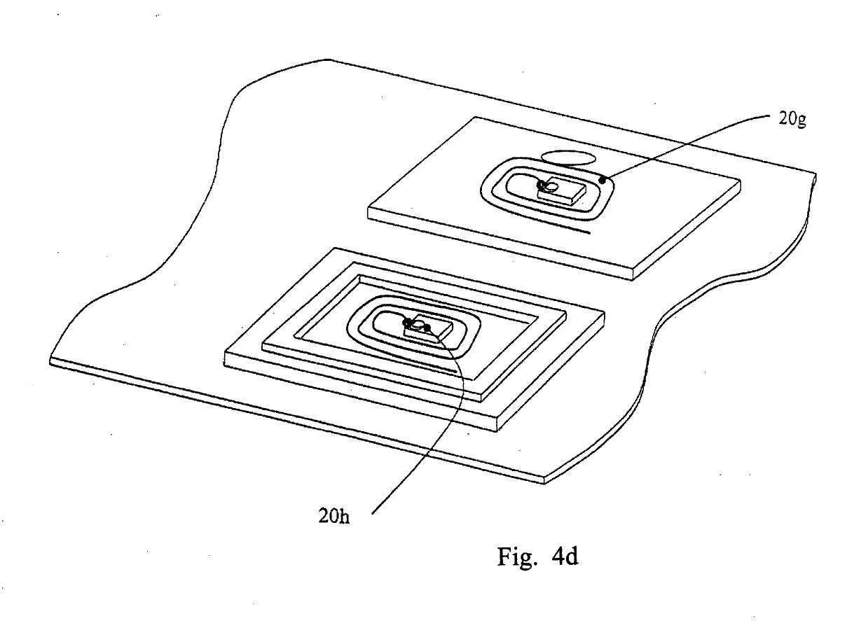

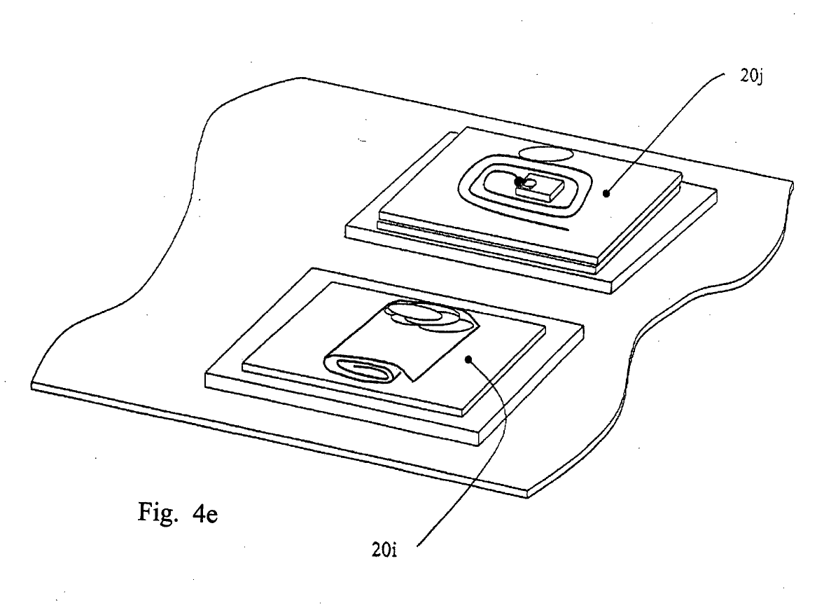

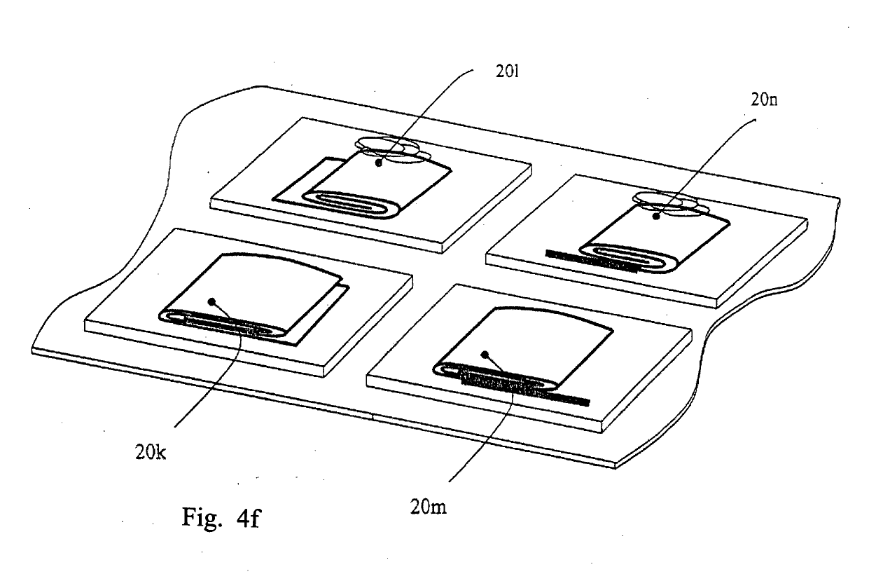

FIGS. 4a to 4e provide example of various types of label components. As can be seen in FIG. 4a, the applied label component may be in the form of a label 20a or a folded sheet or corrugated type of product 20b. FIG. 4b illustrates a label component having an embossed surface 20c and one including an electrical device and battery 20d. In FIG. 4c, the label component includes a leaflet 20f, label, piece of paper, card, plastic or component with a cut out portion 20e, or a folded leaflet.

FIG. 4d depicts a label component comprising an electronic chip 20g. As can be seen in this figure, the chip 20g may be located within a cut out label 20h, such that the label 20e forms a frame or spacer element, to protect the electronic component.

As can be seen in FIG. 4e, multiple label components may be applied to a single carrier label, such as a combination of a label and a leaflet 20i, or a leaflet/electronic chip combination 20j.

As can be seen in FIG. 4f and in FIG. 5, where the label component is a multi-page leaflet, the leaflet can be applied to the carrier label 1 with either the “Closed Folded Edge” leading 20k, or trailing 201, in the direction of travel of the carrier web 2. Alternatively, the folded edge of the leaflet may be located underneath the leaflet in-situ, and either closed folded edge leading 20m or following 20n.

The provision of a registration system, by way of registration devices 16, ensures that the label components, such as an over-laminate label are dispensed in a phased and controlled way with the respective base carrier label. By keeping the label component application processes as a single continuous in-line operation, significant production costs and register benefits result from being able to register all the base carrier labels, the individual label components and any over-laminate labels far more accurately to each other than by having them being produced and applied in a non continuous in-line way.

It has been found that typical register accuracies of ±0.25 mm, and better, are achievable on a run and this has particular relevance to such market areas as electronics and multi-label composites which require such high accuracy for such aspects as ensuring that electrical connections between circuit board/smart card/battery are achieved.

Such high register accuracies have been difficult to achieve in the past when using disjointed non-continuous batch production and particularly when using web materials of PE and PP which have tended to deform and cause registration movement through geometric shrinkage changes by virtue of the nature of the processes (e.g. using UV inks and hot UV lamps to cure the inks), or through register loss through having to re-register each time the next stage of production takes place.

Also, as the manufacturing process is completed in a continuous and linked process, it allows the register and control systems to be directly linked at each stage of the process, and thus avoids unnecessary re-winding and unwind of the carrier substrate. As the label components may comprise relatively bulky layers, any winding/re-winding would tend to distort the geometric forms of the components and contribute to poorer registering in subsequent processing.

If required, information, text and/or images may be applied to the various surfaces of the layers, including the over-laminate label, the label component layer and the base carrier label 1 by means of foil blocking 27, thermal transfer, printing of inks by such means as Flexographic, Lithographic, Screen, Gravure, Letter Press using direct, off-set or indirect means such as ink jet. The application of the image and information may take place at several positions in the process of composing the multi-layered composition, and depends on such aspects as the number of colours, quality of print, number of foils or holograms. The various label components may also receive special finishing processes such as embossing, serrations and creasing, and these processes may take place off-line.

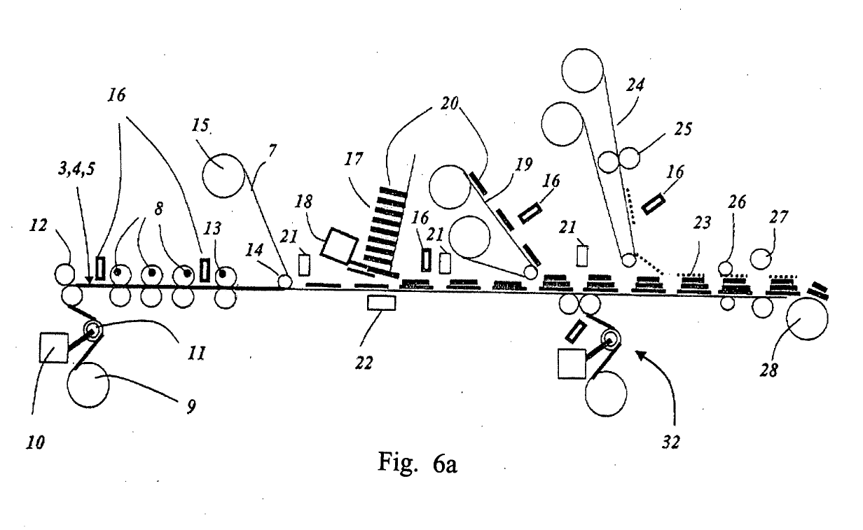

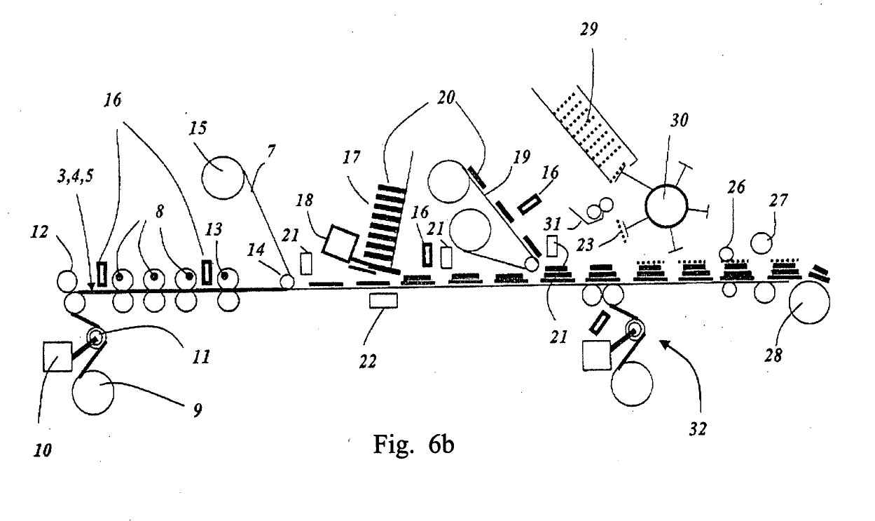

In some instances there are production benefits in facilitating the insertion of a carrier web with base carrier labels with possible specific layers prior to the over-labelling stage, or further upstream of this process such as prior to the Label/Leaflet/Booklet/Electrical Component application section. Such insertions would be achieved by an un-wind and in-feed unit such as shown by system 32 in FIGS. 6a & 6b.

The method of the present invention allows labels and leaflets to be applied to the base carrier, which may have very specific properties which make it difficult to process in the normal way of manufacturing label leaflets directly with the carrier label.

For example, the method would be applicable for labels with very high emboss/debossing effects which would normally cause the carrier substrate and carrier label to be deformed or damaged as a result of the embossing/debossing process, if applied using conventional methods. This is because the deep embossed areas may cause the carrier label to have “air packets” and “bubbles”, leading to “unsightly” or “uneven” affixing of the carrier label to the container on which it is being applied to. Such air pockets, deformations and damage may allow water, dust or dirt to be trapped between the carrier label and container to which it is affixed. In some situations problems of storage, hygiene, strength, functionality of the label/container, as well as having undesirable aesthetics and discolouration issues may result.

There are other applications requiring the facility to apply labels and leaflets with specific folds or 3-D geometric forms, which would otherwise be difficult or impossible to form with the base carrier label and carrier substrate.

Some applications would require different and special adhesives for fastening the label or leaflet to the base carrier label and the adhesive properties between the base carrier label and container. With the method of the present invention, variations of adhesive can be adjusted at the time of applying the specific layer to the base carrier label.

The properties mentioned above may relate to specific uniquely customised Braille labels being affixed to a more standard set of base carrier labels and carrier substrate, which would facilitate current status information to be attached at the point of affixing the carrier label.

The properties mentioned above may relate to the ability to foil block or apply holographic or other security information such as RFID tags to a base label, or as part of a composite label, because of its material composition and for which it would not have been possible to do with the base carrier label and associated carrier substrate directly because of the sensitive nature of the materials involved such as deformation and property changes through low glass transition temperatures, damage to strength properties, or permanent deformation of the carrier label or carrier substrate.

The method defined in this application allows the ability to be able to create certain off-line labels or leaflet images using special printing processes and apply these to the already existing label stock.

Several labels can be applied to one base carrier label to allow the “sandwiching” of labels and leaflets with such specific properties mentioned above in order to combine the above effects and characteristics.

From a geometric and sequencing perspective, the specific layers being placed can vary in type, shape, pitch or sequence onto the base carrier labels which themselves can vary in type, shape, pitch and sequence by means of appropriate controlling systems and the associate number of dispensing units.

Security and other electronic features such as RFID tags can applied to the base carrier label or, applied over another label or leaflet.

As discussed earlier, significant production cost and register benefits exist when producing such combination products which has particular benefits in such markets as the electronic security markets and markets involving relatively geometrically sensitive materials such as PE and PP plastics. These can be affected by heat from ink curing processes and the un-winding and re-wind of the substrate and materials if using a prior art non-continuous process route, particularly when there is a thickness variations associated with a number of combined label components, which tends to deform the adjacent layers when re-wound onto a reel for storage.

Therefore, as can be seen from the above-described embodiments, the method of the present invention provides much increased flexibility when compared with existing production methods. Prior art methods restricted in-line production either to fairly basic end-label designs, or relied on manufacture using numerous distinct process stages, with the attendant registration problems and high production costs. The flexibility to vary the end-label product both across the width and/or along the length of the web has simply not been available previously using prior art methods.

1-21. (canceled)

22. A method of producing self-adhesive labels carried on a release backing material, the method comprising the steps of:
providing a plurality of self-adhesive carrier labels across the width of a web of carrier substrate;
applying at least one discrete label component to each respective carrier label;
characterised by providing a plurality of separate label component applicators across the width of the web, one for each respective label component to be applied; and
providing registration means to ensure registration of each label component with its respective carrier label.

23. A method according to claim 22 wherein the self-adhesive carrier labels are manufactured from a web of label stock as part of the in-line process.

24. A method according to claim 22 wherein the label components comprise a label, a leaflet, a booklet, a film, a decorated laminate, a multi-layered leaflet, a battery and/or electronics in the form of a circuit board, a micro-chip, a smart card, a security tag.

25. A method according to claim 22 wherein the label component comprises a booklet or multi-layered leaflet.

26. A method according to claim 25 wherein the leaflet or booklet is stitched, spine glued, glued-seam, or has an extended flap or an extended cover.

27. A method according to claim 22 wherein adhesive applications stages are included to provide for permanent or releasable adherence of multiple label components to the base carrier label and/or other label components.

28. A method according to claim 22 wherein the label component applicator comprises an over-labelling applicator, a web or sheet feed applicator and/or a hopper dispenser.

29. A method according to claim 22 wherein the end label comprises more than one base carrier label (having its own label component(s)) placed on top of another base carrier label, having its own combination of label components.

30. A method according to claim 22 wherein the label component is raised across the width of the web.

31. A method according to claim 30 wherein the geometric shape, image and/or information of the label component is varied across the width of the web.

32. A method according to claim 22 wherein the label component is varied along the length of the web.

33. A method according to claim 32 wherein the geometric shape, image and/or information of the label component is varied along the length of the web.

34. A method according to claim 22 wherein the labels are introduced randomly across the width of the web.

35. A method according to claim 22 wherein the labels are introduced randomly along the length of the web.

36. A method according to claim 22 wherein the characteristics of the labels are varied over time thereby providing a variety of end label types within a particular stream.

37. A method of producing self-adhesive labels carried on a release backing material, the method comprising the steps of:
providing a self-adhesive carrier labels on a web of carrier substrate;
characterised by applying a plurality of discrete label components across the width of the label;
providing a plurality of separate label component applicators across the width of the label, and
providing registration means to ensure registration of each label component with its respective carrier label.

38. A method according to claim 37 wherein a separate label component applicator is provided for each respective label component to be applied.

39. A method of producing self-adhesive labels carried on a release backing material, the method comprising the steps of:
providing a plurality of self-adhesive carrier labels across the width of a web of carrier substrate;
applying at least one label component to each respective carrier label;
characterised by providing a plurality of separate label component applicators across the width of the web, one for each respective label component to be applied; and
providing registration means to ensure registration of each label component with its respective carrier label.

40. A method according to claim 39 wherein a label component may be applied across one or more of the carrier labels.

41. A method according to claim 40 wherein the label component may comprise a multiple leaflet, or an over-laminate film.
